(19) United States
(12) Patent Application Publication
(10) Pub. No.: US 2020/0062419 A1
(43) Pub. Date: Feb. 27, 2020

(54) PORTABLE DRONE POD

(71) Applicant: Ford Global Technologies, LLC, Dearborn, MI (US)

(72) Inventors: Alvaro JIMENEZ HERNANDEZ, Mexico City (MX); Oswaldo PEREZ BARRERA, Estado De Mexico (MX)

(21) Appl. No.: 16/498,420

(22) PCT Filed: Mar. 27, 2017
(86) PCT No.: PCT/US2017/024227

§ 371 Date: Sep. 27, 2019

(51) Int. Cl. B64F 1/00; B64C 39/02; E05F 15/73

(52) U.S. Cl. CPC B64F 1/007; B64C 39/024; B64F 1/364; B64C 2201/208; B64C 2201/201; E05F 15/73

(57) ABSTRACT

A drone pod includes a pod shell, a door, a motor and a computer. The pod shell includes a base, a top, and a wall. The top has an opening sized to receive a drone. The wall connects the base and the top. The door is disposed in the opening. The motor is drivingly connected to the door. The computer is programmed actuate the motor to open and close the door responsive to an operation of the drone.

### BACKGROUND

A drone, i.e., an unmanned aerial vehicle, can be used for various operations, such as data gathering and communications. Drones can have limited ranges and it may not be desirable to launch a drone until it is needed and/or in a location where the drone can be useful. However, present motor vehicles are not well suited to carrying drones in a fashion that both protects the drones and allows convenient launching and recovery of drones. There is a need for a device and system facilitating the easy and safe transport of drones that further allows easy drone launching from and recovery.

### BRIEF DESCRIPTION OF THE DRAWINGS

FIG. 1 is a side view of an example vehicle having an example pod.

FIG. 2A is a section view of the example pod of FIG. 1 with an example sectional door closure in a closed position.

FIG. 2B is a section view of the pod of FIG. 2A with the door closure in an open position.

FIG. 3A is a section view of an alternative configuration of a pod with an example roll-up door closure in a closed position.

FIG. 3B is a section view of the pod of FIG. 3A with the door closure in an open position.

FIG. 4 is a partially exploded view of the pod of FIGS. 3A and 3B, showing a battery and charger in more detail.

FIG. 5 is an enlarged section view of an example lock.

FIG. 6 is a schematic illustration of a drone control communication network and a pod network.

FIG. 7 is an example flow chart of a pod management process.

### DETAILED DESCRIPTION

Relative orientations and directions (by way of example, upper, lower, bottom, forward, rearward, front, rear, back, outboard, inboard, inward, outward, lateral, left, right) are set forth in this description not as limitations, but for the convenience of the reader in picturing at least one embodiment of the structures described. Such example orientations are from the perspective of an occupant seated in a seat, facing a dashboard. In the Figures, like numerals indicate like parts throughout the several views.

A drone pod includes a pod shell, a battery, a motor and a computer. The pod shell includes a base, a top, a wall, a door, a battery, a motor and a computer. The top has an opening sized to receive a drone. The wall connects base and the top. The door is disposed in the opening. The motor is electrically connected to the battery and is drivingly connected to the door. The computer is communicatively coupled to the motor and is programmed to selectively open and close the door responsive to an operation of the drone. In the context of this disclosure “communicatively coupled” means connected in a wired or wireless manner such as is known to receive data and/or provide commands.

A drone pod includes a pod shell, a door, a battery, a motor and a computer. The pod shell includes a base, a top and a wall. The top includes an opening sized to receive a drone. The wall connects the base and the top. The door is disposed in the opening. The motor is electrically connected to the battery and is drivingly connected to the door. The computer is programmed to actuate the motor to open and close the door responsive to an operation of the drone.

The computer of the drone pod may be further programmed to actuate the motor to open the door responsive to a determination that the drone is within a predetermined distance of the pod.

The drone pod may further include a battery charger electrically connected to the battery.

The drone pod may further include a docking station sensor. The computer may be further programmed to detect a presence of the drone within the pod based on data from the docking station sensor and to actuate the motor to close the door.

The drone pod may further include a wireless transceiver.

The drone pod may further include a selectively actuatable door lock communicatively coupled to the computer.

The drone pod may further include a door-open sensor located at a start of travel position of the door and communicatively coupled to the computer.

The drone pod may further include a door-closed sensor located at an end of travel position of the door and communicatively coupled to the computer.

The drone pod may further include a GPS sensor communicatively coupled to the computer. The computer may be further programmed to use data from the GPS sensor to determine a distance between the drone and the pod.

The drone pod may further include a drone proximity sensor communicatively coupled to the computer.

A method of deploying and recovering a drone includes the steps of providing a drone, providing a drone pod, and actuating the motor. The drone pod includes a pod shell, a door and a motor. The pod shell includes a top with an opening sized to receive the drone. The door is disposed in the opening. The motor is drivingly connected to the door. The motor is actuated to open and close the door responsive to an operation of the drone.

The method may further include the step of actuating the motor to open the door responsive to a determination that the drone is within a predetermined distance of the pod.

The method may further include the steps of providing a battery within the pod, providing an inductive battery charger, and charging a drone battery. The inductive battery charger is electrically connected to the battery. The drone battery is charged wirelessly in the pod when the drone is within the pod.

The method may further include the steps of providing a docking station sensor, determining that the drone is within the pod, and actuating the motor. The docking station sensor is responsive to a presence of the drone within the pod. The determination of the drone being within the pod is based on data from the docking station sensor. The motor is actuated to close the door responsive to the determination that the drone is within the pod.

The method may further include the steps of providing a wireless transceiver and communicating date over the wireless transceiver. The wireless transceiver allows communication between the pod and the drone.

The method may further include the steps of providing a door lock, providing a door-closed sensor, determining that the door is closed, and actuating the door lock. The door lock is selectively actuatable and has a first condition in a locked mode and a second condition in an unlocked mode. The door-closed sensor is responsive to the door in a closed position. The determination of the door being closed is based on data from the door-closed sensor. The door lock actuation places the lock in the locked mode responsive to a determination that the door is closed.

The method may further include the steps of providing a door-open sensor, determining that the door is open, communicating a signal to the drone, and landing the drone inside the pod. The door-open sensor is located at a start of travel position of the door. The determination that the door is open is based on data from the door-open sensor. The signal communicated to the drone is indicative of the door being open and is responsive to a determination that the door is open. The drone is landed upon receiving the signal indicative of the door being open.

The method may further include the steps of providing a door-closed sensor, providing a docking station sensor, determining that the drone is within the pod, actuating the motor to close the door, and determining that the door is closed. The door-closed sensor is located at an end of travel position of the door. The docking station sensor is responsive to a presence of the drone within the pod. The determination that the drone is within the pod is based on data from the docking station sensor. The actuation of the motor is responsive to the determination that the drone is within the pod. The determination that the door is closed is based on data from the door-closed sensor.

The method may further include the steps of providing a GPS sensor in the pod, providing a GPS sensor in the drone, and determining a distance between the pod and the drone based on data from the GPS sensors.

The method may further include the steps of providing a drone proximity sensor, determining a distance of the drone from the pod based on data from the proximity sensor, and actuating the motor to open the door when the drone is within a predetermined distance of the pod.

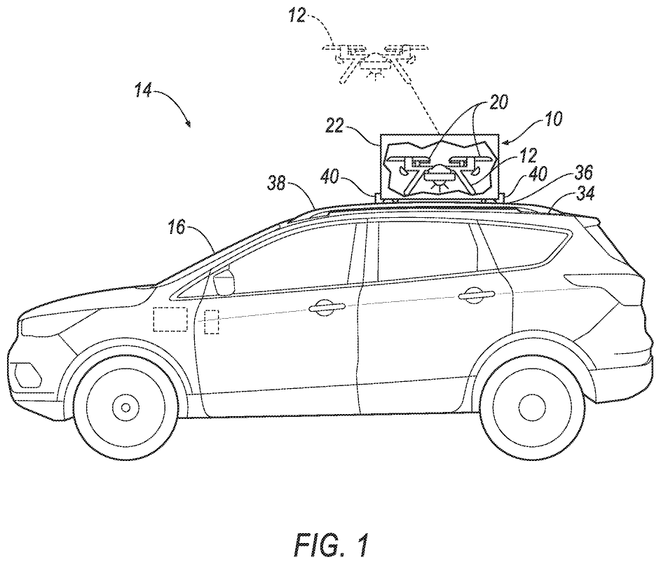

A portable drone carrier and launch pad and landing pad system, i.e., a pod 10 for a drone 12, as illustrated in FIGS. 1-6, may be part of a mobile drone launch and recovery and transport and storage system, i.e., a mobile drone system 14, that includes a motor vehicle 16 and may also include a hand-held control device, e.g. a cellular phone 18. The motor vehicle 16 is a wheeled or tracked vehicle including, by way of example, passenger cars and trucks.

Drone as used herein means an unmanned aerial vehicle. Drones can be either autonomous or non-autonomous. Autonomous drones have operation parameters, e.g., speed, direction, altitude, etc., controlled by a computer. Non-autonomous drones are controlled by a remote human operator.

Drones are available with a variety of aeronautic performance capabilities. For example, drones may have a fixed wing configuration requiring either a runway or a launch assist device, e.g., a catapult, to get airborne. Alternatively, drones may have rotors 20 with rotating airfoils, i.e., rotor blades, allowing substantially vertical launches and landings. A helicopter-type drone may include a single rotor or two rotors.

Drones may have more than one or two rotors. For example, the illustrated example drone 12, a quadcopter, has four rotors 20. Other configurations may include a bicopter with two rotors, a tricopter with three rotors, a hexacopter with six rotors, an octocopter with eight rotors, and so on.

Aerial drones, particularly when used in combination with land-based motor vehicles, may be used to support public safety agencies, fire departments, search and rescue operations, wildlife research, scientific research, agriculture, meteorology, aerial mapping, pollution monitoring, and the like.

The example drone 12 is driven by four electric motors (not shown), one for each rotor 20. The drone 12 carries an on-board battery, i.e., a drone battery 21, that provides electrical power to the drone 12 and to all on-board electronics.

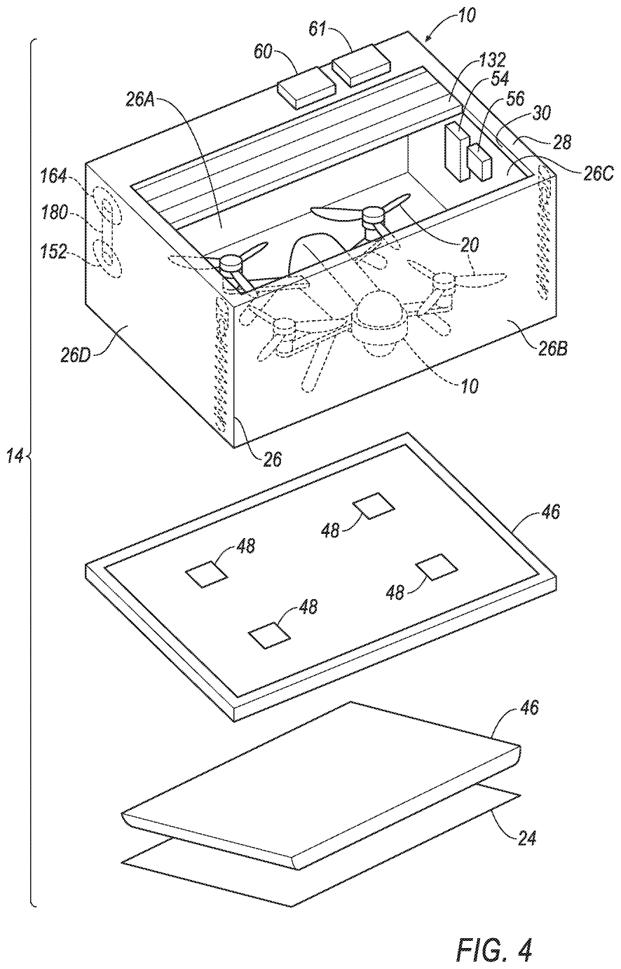

The pod 10 includes a pod shell 22. The example pod shell 22 may be in the shape of a rectangular box with a bottom side or base 24 that is substantially rectangular in shape as illustrated in FIGS. 1-4. The illustrated pod shell 22 provides the base 24 and a wall 26 having four sides including, as best shown in FIG. 4, a front side 26A, a rear side 26B, a right side 26C and a left side 26D, surrounding the base 24. The wall 26 is disposed between and connects the base 24 and a top 28. The top 28 provides an opening 30 that is selectively closed by a sliding door 32. The opening 30 is sized to receive the drone 12.

Alternative shapes may be employed for the pod shell 22. The shape of the pod shell 22 is not critical. Further, the pod shell 22 typically has a size relating to the size of the drone 12, and typically also determined according to a size and configuration of the vehicle 16. The pod shell 22 must be sufficiently large to accommodate the drone 12. The pod shell 22 should not exceed a size accommodated by the selected vehicle 16. The shape may be influenced by design choice factors such as aerodynamics, and efficiency of an on-vehicle mounting location. For example, a tear-drop shaped base may better suited to a pod 10 that will be mounted on a vehicle roof 34 than the rectangular base 24. However, if the mounting location is a bed of a pick-up truck (not shown), the rectangular base 24 is more compatible with the available vehicle space, and aerodynamic efficiency is less of a concern. The pod shell 22, when disposed in the bed of the pick-up truck, may not increase an aerodynamic drag of the vehicle 16 by increasing a frontal area of the vehicle 16. One benefit of the rectangular base is that a similarly shaped top 28 will be complementary in shape to the rectangular sliding door 32, providing a smaller overall size for the pod shell 22 than more streamlined packaging may allow.

The door 32, described in more detail below, is sufficiently large in an open position to allow the drone 12 to enter and exit the pod shell 22. In a closed position, the door 32 protects the drone 12 from the weather, theft and vandalism.

One example mounting location of the pod 10 is illustrated in FIG. 1. The pod 10 is mounted on a vehicle roof rack 36. An example roof rack 36 may include roof rails 38 integral to the vehicle, fixed to a body structure of the vehicle 16 in a fore-aft direction at or near an outboard edge of the roof 34. Cross rails 40 may extend laterally across the roof rails 38 and may be selectively positioned thereon and fixed thereto. The pod 10 may be mounted to cross rails 40. Alternatively, a roof rack 36, not formed as part of the vehicle 16, may be mounted to the vehicle roof 34 in a known manner. The nature of the roof rack 36 may vary, as long as the roof rack 36 can support the combined weight of the pod 10 and the drone 12.

The pod shell 22 may have mounting features (not shown) for tying it to the cross rails. Example known mounting features can be found in known car-top carriers, and may include a plurality of bolts, washers and steel plates.

The pod 10 may include a pod battery 44 and a drone battery charger 46 and plurality of docking station sensors 48 disposed within the pod shell 22 that indicate the presence of the drone in a predetermined location within the pod 10, as on a docking station. Example docking station sensors 48 may be weight measurement sensors 48 disposed over or on the battery charger 46.

The charger 46 may be an inductive charger. Inductive chargers are known and are commercially available. The charger 46 may be powered by and electrically connected to the pod battery 44. When the drone 12 is disposed over the charger 46, e.g., in a docking station, the charger 46 charges the drone battery 21 via an inductive coupling between the drone battery 21 and the inductive charger. Charging the drone battery 21 may thus be achieved wirelessly, avoiding a need to manually connect the drone 12 to the charger 46.

The pod battery 44 may be charged prior to loading the pod 10 onto or into the vehicle 16. The pod battery 44 may alternatively be charged by power from a vehicle battery system 50. The pod battery 44 may incorporate charging circuitry to accommodate connecting to the vehicle battery system 50. A power port (not shown) may be provided in the pod shell 22 to allow a charging connector (not shown) to be received by pod 10.

The pod battery 44 may also power a motor 52 for operating the door, a pod communication system 54, a door lock 55, and a pod electronic control unit (“ECU”) 56. The battery 44 may include charge management circuitry and charge management instructions. The ECU 56 is a computing device, i.e., a computer, and includes an electronic processor 57 and an associated memory 58. The memory 58 includes one or more forms of computer-readable media, and stores instructions executable by the processor 57 for performing various operations, such as opening and closing the door 32 responsive to a flight status of the drone 12. The processor 57 may read and execute such instructions in a known manner.

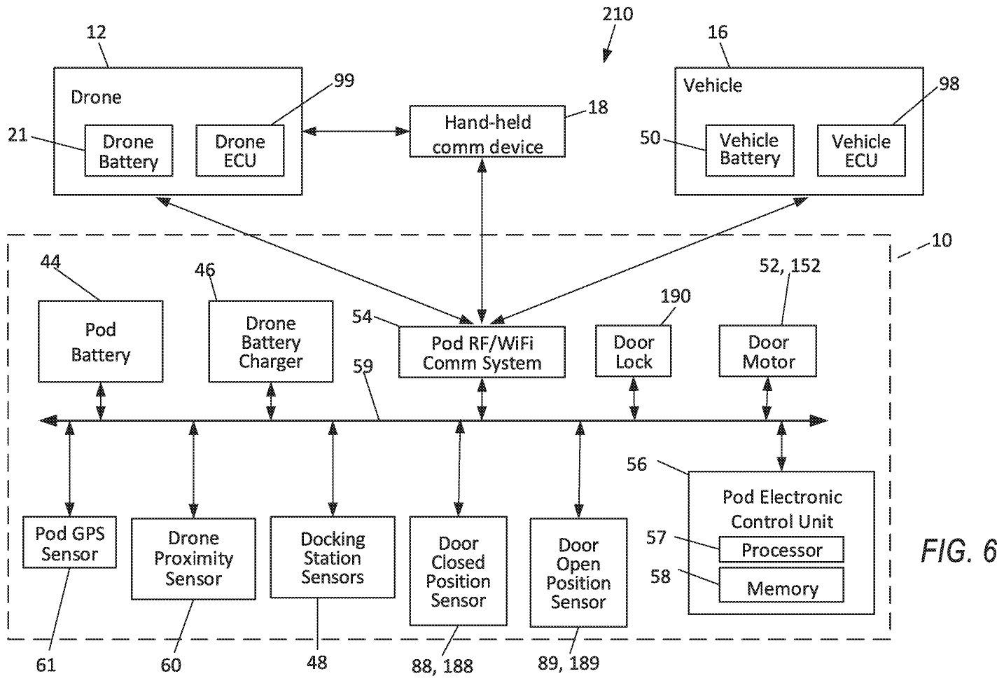

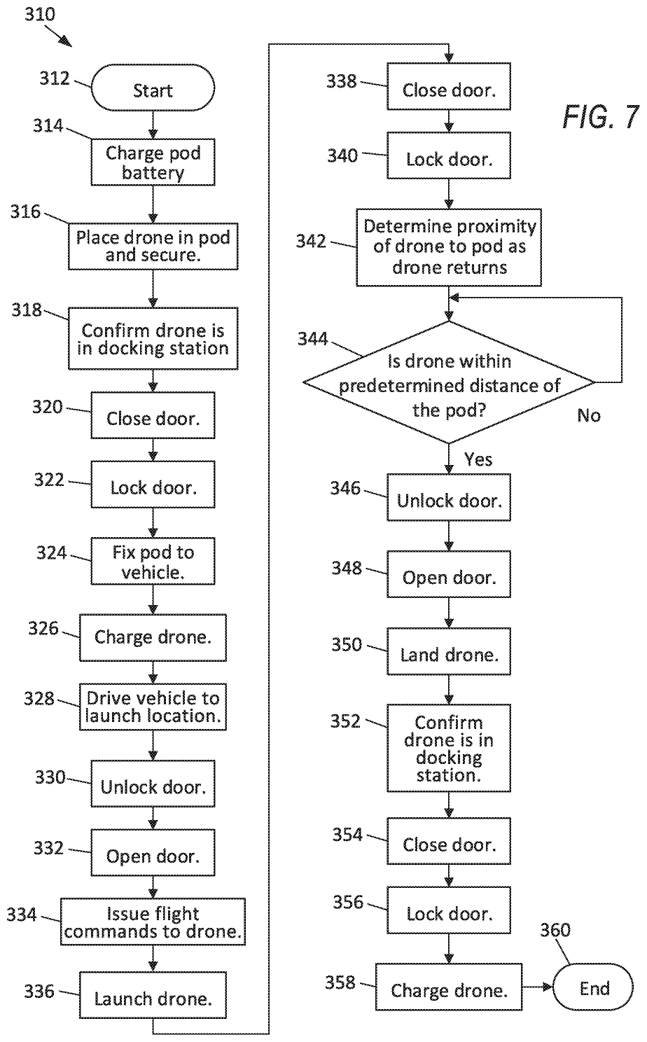

Each of the battery 44, the drone battery charger 46, the docking station sensors 48, the motor 52 for operating the door 32, the pod communication system 54, the door lock 55, and the pod ECU 56, and additional components as described below, may all electrically connect to a pod network 59 as shown in FIG. 6. The network 59 may include one or more wired and/or wireless communications media such as an example system Control Area Network (“CAN”) bus or a Local Interconnect Network (“LIN”) and/or other communications media. Electrical connections to the ECU 56 of sensors and actuators may be made through the network 59 by wire and/or devices may be wirelessly communicatively coupled, as with Bluetooth® signal transmitting equipment and methods, or with other wireless signal transmission technology.

The pod communication system 54 is a wireless communication system including a wireless transceiver, and may provide radio frequency communication for communication between the drone 12 and the pod 10. Radio frequency communication may be supplemented by the communication system 54 providing WiFi communications for short-range communication, e.g., communication over a distance of less than 30 meters.

A drone proximity sensor 60, e.g., a motion sensor, may also be included in pod 10 and connected to network 59. The drone proximity sensor provides data indicative of the drone 12 being outside of the drone pod 10 within a predetermined range, e.g., 10 meters, of the drone pod, and may determine the distance of the drone 12 from the drone pod 10. A signal from the sensor 60 indicating that the pod 10 is nearby may be used by the ECU 56 as a trigger to open the door 32. Providing a Global Positioning System (“GPS”) sensor 61 in the pod 10 and a GPS sensor (not shown) in the drone 12 may also allow a determination of a proximity of the drone 12 to the pod. The GPS sensor 61 may also be connected to the pod network 59.

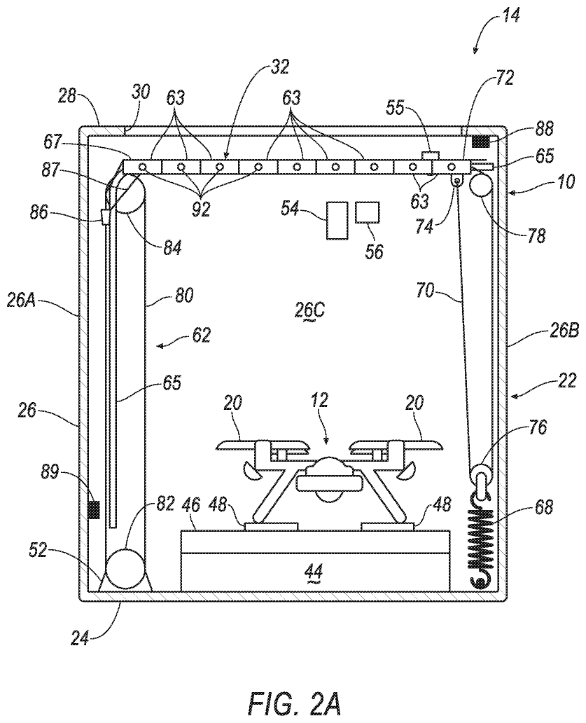

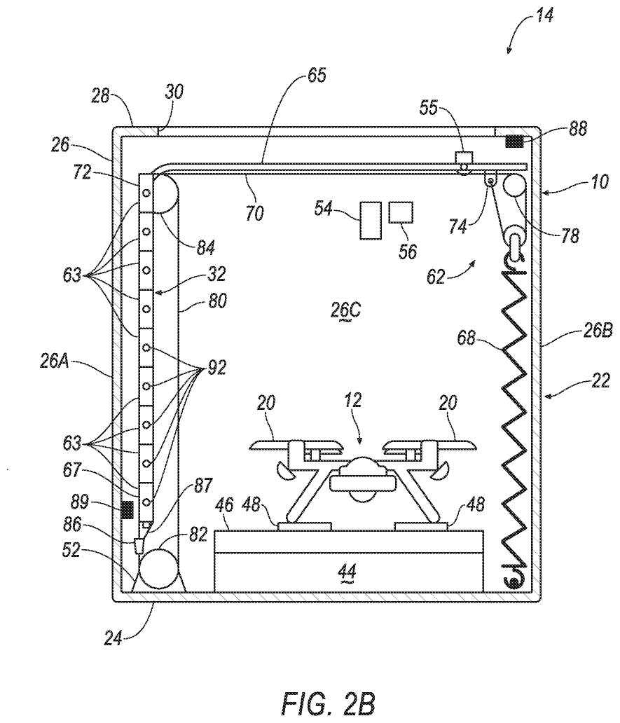

FIGS. 2A and 2B illustrate a first example door actuating mechanism 62. The door 32 is a sectional door, comprising a plurality of articulated panels 63, and similar in nature to a sectional garage door. An example number of panels 63 is nine, as illustrated, but the number may vary. Each panel 63 may be hinged to the next. The panels 63 are supported on each side by a supporting track 65. Pins or rollers (not shown) may extend from the panels 63 for receipt by the track 65. The pins or rollers are slidably disposed within the track 65. The track 65 may be in the form of a metal or plastic channel.

The door motor 52 may be connected to a first end panel 67 of panels 63 to act against a restoring force tending to move the door 32 to a closed position. A pair of springs 68, one on the left and right sides of the door 32, may provide the restoring force, biasing the door to the closed position. Two possible alternative sources of the restoring force are a motor and gravity in combination with a counterweight.

Force from the springs 68 is communicated by associated cables 70 to a second end panel 72 on an end of door 32 opposite the first panel 67. Each cable 70 is connected on one end to the second end panel 72, and on the opposite end to a bracket 74 fixed to one of the right side 26C and the left side 26D of the wall 26 of the pod shell 22. Left side 26D, not shown in FIGS. 2A and 2B, has the same relative location to right side 26C as shown in FIG. 4. Each cable 70 is connected along its length to the spring 68 by a first door pulley 76 in engagement with the cable 70. A second door pulley 78 may redirect the force from a vertical direction to a horizontal direction.

The motor 52 is located near the base 24 and is connected to a drive chain 80 or alternatively a cable via a first drive pulley 82. When a chain 80 is employed, the pulley 82 may be in the form of a sprocket-type gear. A second drive pulley 84 or gear located near the top 28 of the pod is also engaged by the chain 80. A carrier 86 is fixed to the chain and moves with the chain 80. A connecting rod 87 may be fixed on one end to the carrier 86 and on another end to the first end panel 67. The motor 52, chain 80, gears 82, 84, carrier 86, connecting rod 87 etc., may be located approximately in a center of the door 32, substantially mid-way between the two tracks 65. Movement of the chain 80 and the carrier 86 results in movement of the door 32.

A first door sensor, i.e., a door-closed sensor 88, may be mounted to the pod shell 22 at an end of travel position of the door 32 and allows detection of the door 32 in a fully closed position. A second door sensor, i.e., a door-open sensor 89, may be mounted to the pod shell 22 at a start of travel position of the door 32 and allows detection of the door 32 in a fully open position. The sensors 88, 89 may also be connected to the pod network 59.

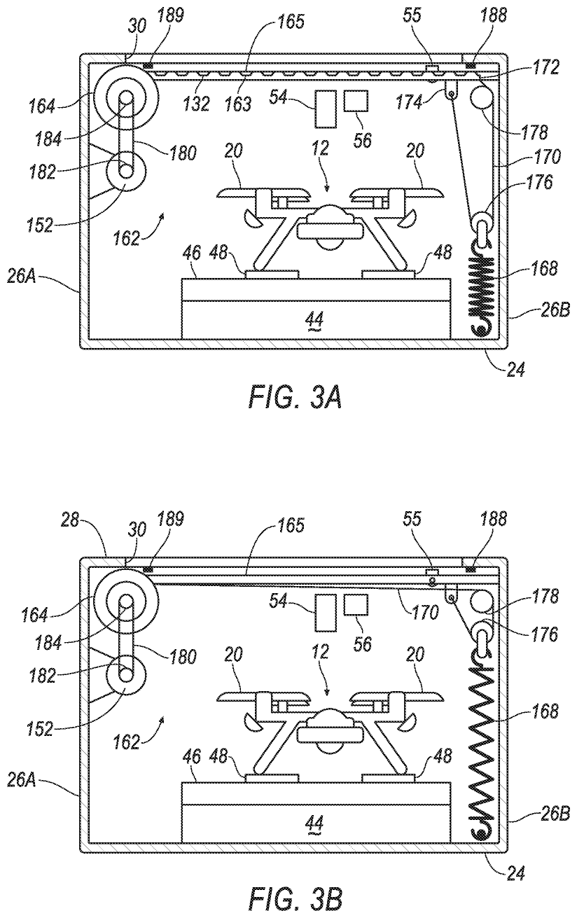

FIGS. 3A and 3B illustrate an alternative configuration of a door 132 and door actuation mechanism 162. The door 132 is a roll-up door 132, comprising a substantially uninterrupted corrugated sheet 163. Larger versions of corrugated doors are known and are commercially available for use as garage doors and store-front night-time security doors; the doors 132 could be smaller versions of such doors. The sheet 163 may be made of materials including aluminum and steel and composite filled polymers. Yet alternative door configurations may be based on roll-up doors for tool boxes, and roll-up doors for bread boxes.

In a first or closed-door position, the sheet 163 is extended to close the opening 30 in the top 28 of the pod shell 22. In a second or open position, the sheet 163 is wrapped about a door spool, disposed within a containment cylinder 164. Cylinder is fixed within pod shell 22, laterally extending between sides 26C and 26D and proximate to the rear side 26B. Left side 26D, not shown in FIGS. 3A and 3B, has the same relative location to right side 26C as shown in FIG. 4. The sheet 163 may be supported on each side by a supporting track 165 which slidably receives peripheral edges of the sheet 163.

A door drive motor 152 may be connected to the spool disposed inside the cylinder 164. The drive motor 152 may be in fixed connection with a first pulley or a gear 182 for unitary rotation therewith, connecting to a second pulley or gear 184 fixed to the spool on a side of the cylinder 164 via a driving cable or chain 180. The motor 152 may also be connected to the pod network 59.

To open the door, the motor 152 acts against a restoring force tending to move the door to a closed position. A pair of springs 168 may provide the restoring force. Example alternative sources of the restoring force may include a motor, or gravity in combination with a counterweight. The restoring force from the springs 168 is communicated by cables 170 connected to a bottom edge 172 on one end of the sheet 163 that may be reinforced, and to a bracket 174 that may be fixed to the side 26C, 26D of the pod shell 22 on the other end and connected to the spring 168 by a first door pulley 176. As noted above, left side 26D, not shown in FIGS. 3A and 3B, has the same relative location to right side 26C as shown in FIG. 4. A second door pulley 178 may redirect the force from a vertical direction to a horizontal direction.

The motor 152, chain 180, pulleys 182, 184, etc., may be located on either side of the door, proximate to one of the sides 26C, 26D of the pod shell 22.

A first door sensor, i.e., a door-closed sensor 188, may be mounted to the pod shell 22 at an end of travel position of the door 132 and allows detection of the door 132 in a fully closed position. A second door sensor, i.e., a door-open sensor 189, may be mounted to the pod shell 22 at a start of travel position of the door 132 and allows detection of the door 132 in a fully open position. The sensors 188, 189 may also be connected to the pod network 59.

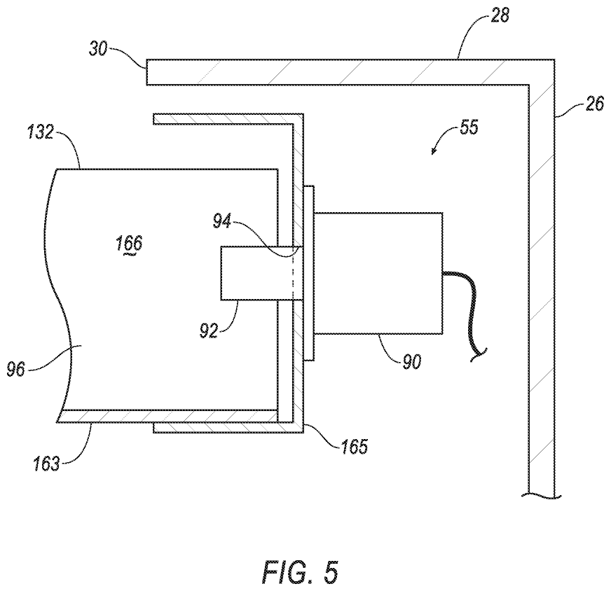

The door lock 55 is selectively actuatable, and may be an electronically actuated lock 55 as illustrated in FIG. 5. The lock 55 may include an electronically actuated solenoid 90. The solenoid is illustrated as being fixed to an outboard surface of the track 165. The solenoid 90 may include a spring biasing a pin 92 to one of an engaged and a disengaged position, i.e., a locked and an unlocked position, the solenoid 90 requiring energization of a solenoid coil to achieve the other position. A clearance aperture 94 is provided through the track 165 to accommodate the passage of the pin 92. An attempt to move the sheet 163 in the track 165 is blocked by engagement of a corrugation groove surface 166 of groove 96 with the pin 92.

The solenoid 90 can be one that is biased to the engaged position or biased to the disengage position, as just explained. The use of a solenoid that requires energization to remain latched may require more power during the use of the pod 10 than one that requires energization to unlatch. A solenoid that requires energization to unlatch may, in the event of failure of the solenoid to respond to a command signal, may trap the drone 12 inside the pod 10 until the solenoid 90 can be removed. The lock 55 is in a locked mode exhibits a first condition in which the pin 92 is in a locked position. In the locked position, the pin 92 is disposed in a corrugation groove 96, blocking the door 132 from moving within the track 165 a distance any greater than one corrugation length. In an unlocked mode, the lock exhibits a second condition in which the pin 92 is in an unlocked position. In the unlocked position, the pin 92 is withdrawn from the corrugation groove 96 and from a channel of the track, allowing unimpeded movement of the door 132 within the track 165.

A similar lock configuration works with the configuration of FIGS. 2A and 2B, employing panels 63 in place of the sheet 163. An aperture may be placed in a plate (not shown) defining part of the door. The aperture may receive the pin 92 much as the corrugation groove receives the pin 92 in FIG. 5.

An example drone control communication network 210, as illustrated in FIG. 6, includes the pod 10, the drone 12, and the hand-held control device 18, all linked together by wireless communication.

The drone pod 10 may operate in accord with the example pod operation process 310 of FIG. 7, described below. The process may be in-part stored in the ECU memory 58 and carried out cooperatively by the pod 10 and the drone 12. Some steps may be executed manually.

The process 310 is initiated in start block 312. Moving to process block 314, the drone pod 10 has its battery 44 charged. This step may be done manually with the pod 10 having a power source such as a power cord (not shown) from the vehicle battery system 50 manually plugged into its power port. Alternatively, an on-vehicle charging system (not shown) may include a power cord extending from the vehicle battery system 50 and connecting to the power port of the pod 10. With the power cord electrically connected to the pod 10, the circuitry of the battery 44 may control the charging, or, alternatively, the ECU 56 may be programmed to manage charging the battery 44.

In process block 316, the drone 12 is placed in the pod 10 and is secured therein by a docking station. The placement of the drone 12 inside the pod 10 may be done manually. Alternatively, when there is adequate space, and the battery 21 of the drone 12 is sufficiently charged, the drone 12 may be flown into the pod 10 under control of a drone computer, i.e., a drone ECU 99. Securing the drone 12 in the pod 10 may be done responsive to commands from the ECU 56 to facilitate the ECU 56 being able to later release the drone 12 without human intervention.

The process 310 moves to process block 318 to confirm that the drone 12 is in the docking station. The hand-held control device 18 may be used by a human drone operator to communicate with each of the drone 12 and the pod 10. For process block 318, the hand-held control device 18 may be used by the operator to confirm that the drone 12 is placed on the sensors 48 and is secured and is thus in the docking station. Signals from the docking station sensors 48 communicated on network 59 may be in turn communicated by communication system 54 to the hand-held control device 18. Alternatively, process block 318 may be executed by the ECU 56 receiving a signal from sensors 48 that the drone 12 is properly docked, allowing ECU 56 to confirm that the drone 12 is in the docking station.

Process blocks 320 and 322 respectively close the door 32, 132 and lock the door 32, 132. Having confirmed that the drone 12 is in the docking station, the hand-held control device 18 may be used by the operator to issue a command to the pod 10 actuating the motor 52, 152 to close the door 32, 132. The sensor 88, 188 issues a signal indicating that the door is closed. Following receipt of the door-closed signal by the hand-held control device 18, the operator may issue a second command to actuate the lock 55 to lock the pod 10. Alternatively, a single command from the hand-held control device 18 may be used by the operator to both close and lock the door 32, 132 with the ECU 56 determining that the door is closed and that the door 32, 132 may be locked. Yet alternatively, the ECU 56 may, through control of motor 52, 152 and lock 55 and with data from sensors 88, 188, 89, 189 close and lock the door 32, 132 after confirming that the drone 12 is in the pod 10.

Once the pod 10 is locked, it may, in accord with process block 324, be loaded onto and secured, i.e., fixed, to the vehicle 16 as are known car-top carriers. The loading of the pod 10 onto or into the vehicle 16 may be achieved manually.

Per process block 328, the vehicle 16 is driven to a selected geographic destination from which the drone 12 is to be launched. This step may be performed by a human driver. Alternatively, the step of driving to the selected geographic location may be achieved by the vehicle 16 when the vehicle is a fully autonomous vehicle. The autonomous vehicle allows control of each of vehicle propulsion, braking, and steering by a vehicle computer, i.e., a vehicle ECU 98.

Upon reaching the destination, the process moves to process blocks 330 and 332 to unlock and open the door 32, 132. The hand-held control device 18 may be used by the operator to command the door lock 55 to unlock and open the door 32, 132. Alternatively, the ECU 56 of the pod 10 may, upon being notified by the vehicle ECU 98 that the vehicle 16 has reached its destination, may unlock and open the door 32, 132. The pod ECU 56 may receive data from sensor 89, 189 confirming that the door 32, 132 is open.

After the door 32, 132 is open, the drone 12, in accord with process block 334, may be given flight commands by the operator through the hand-held control device 18. The drone 12 departs the pod 10 responsive to the flight commands. Alternatively, flight commands could be downloaded from a cloud network and communicated to the drone 12 either directly or via one of the pod 10 and the vehicle 16.

As an alternative to the above-described sequence of the flight commands being received by the drone 12 after opening the door 32, 132, the flight commands may be received by the drone 12 before the door 32, 132 is open, and may be received even before the drone is loaded into the pod 10. Upon confirmation by any of the vehicle, drone and pod ECUs 98, 99, 56 that the vehicle 16, and the accompanying pod 10 and drone 12, have reached the selected geographic destination and that the vehicle 16 has been parked and is stationary, the drone 12 may direct the pod 10 to unlock and to open the door 32, 132.

In accord with process block 336, the drone is launched. The drone ECU 99, complying with the flight commands, directs the drone 12 to leave, i.e., launch from, the pod 10.

After the drone 12 has left the pod 10, the pod door 32, 132 is, as per process blocks 338 and 340, closed and locked responsive to instructions from the pod ECU 56. An initiation of the closing and locking may be triggered by any of several occurrences, including data from the proximity sensor 60 indicating to the pod ECU 56 that the drone 12 has moved beyond a predetermined range from the pod 10, and GPS data indicating the position of each of the drone 12 and the pod 10 being compared to determine that the drone 12 has moved beyond the predetermined range relative to the pod 10. Such a comparison may be made by either the pod ECU 56 or the drone ECU 99.

On the drone's return, its proximity to the pod 10 may be determined using one or more of the available sensors. In satisfaction of process block 342, data from the GPS sensor in the drone 12 may be compared with data from the pod GPS sensor 61 by either the pod ECU 56 or the drone ECU 99 with the date from the other being communicated via the transceiver to determine a distance therebetween. The proximity sensor 60 may be used to determine that the drone 12 is within the predetermined distance, i.e., within a proximity, of the pod 10 as per decision block 344. An example proximity may be 30 meters. When the drone 12 is not within the proximity of the pod 10, the ECU 56 or 99 continues to check the relative distance therebetween. When the proximity of the drone 12 to the pod 10 is within the predetermined distance, the process 310 moves to process block 346.

Per process blocks 346 and 348, the pod 10, upon it being determined that the drone 12 is within the predetermined distance, may unlock and open the pod door 32, 132. The pod ECU 56 may receive data from sensor 89, 189. Based on the data from the sensor 89, 189, the ECU may make a confirming determination that the door 32, 132 is open. The determination may be communicated to the drone 12 as a signal that the drone recognizes as being indicative of the door 32, 132 being open.

In accord with process block 350, the drone 12 enters the pod 10, and lands on the docking station sensors 48. The drone 12 is confirmed as being in the docking station by the pod ECU 56 based on data from sensors 48, as per process block 352.

As per process blocks 354 and 356, once the pod 10 is confirmed as being in its docking station, the door 32, 132 is closed. Closure is confirmed by a signal from sensor 88, 188. After closure is confirmed, the door 32, 132 is locked.

After the door 32, 132 is locked, the drone battery 21 may, consistent with process block 358, be recharged by battery charger 46. Upon completion of charging, the drone 12 is ready for its next flight mission.

The process 310 moves to end block 360 and terminates.

An example portable drone pod 10, an example mobile drone system 14 and an example pod operation process 310 have been disclosed.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

With reference to the computing devices described above, including ECUs 56, 98 and 99, computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored in computer readable media associated therewith (e.g., disks, memories, etc.). A computer program product may comprise such instructions stored in computer readable media for carrying out the functions described herein.

The adjectives “first” and “second” are used throughout this document as identifiers and are not intended to signify importance or order.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

The disclosure has been described in an illustrative manner, and it is to be understood that the terminology which has been used is intended to be in the nature of words of description rather than of limitation. All terms used in the claims are intended to be given their plain and ordinary meanings as understood by those skilled in the art unless an explicit indication to the contrary in made herein. Many modifications and variations of the present disclosure are possible in light of the above teachings, and the disclosure may be practiced otherwise than as specifically described.

What is claimed is:

1. A drone pod, comprising:
a pod shell including:
a base,
a top including an opening sized to receive a drone, and
a wall connecting the base and the top;
a door disposed in the opening;
a battery;
a motor electrically connected to the battery and drivingly connected to the door; and
a computer programmed to actuate the motor to open and close the door responsive to an operation of the drone.

2. The drone pod of claim 1, further comprising the computer further programmed to actuate the motor to open the door responsive to a determination that the drone is within a predetermined distance of the pod.

3. The drone pod of claim 1, further comprising a battery charger electrically connected to the battery.

4. The drone pod of claim 1, further comprising a docking station sensor and the computer further programmed to detect a presence of the drone within the pod based on data from the docking station sensor and to actuate the motor to close the door.

5. The drone pod of claim 1, further comprising a wireless transceiver.

6. The drone pod of claim 1, further comprising a selectively actuatable door lock communicatively coupled to the computer.

7. The drone pod of claim 1, further comprising a door-open sensor located at a start of travel position of the door and communicatively coupled to the computer.

8. The drone pod of claim 7, further comprising a door-closed sensor located at an end of travel position of the door and communicatively coupled to the computer.

9. The drone pod of claim 1, further comprising a GPS sensor communicatively coupled to the computer and the computer further programmed to use data from the GPS sensor to determine a distance between the drone and the pod.

10. The drone pod of claim 1, further comprising a drone proximity sensor communicatively coupled to the computer.

11. A method of deploying and recovering a drone, the method comprising the steps of:
providing a drone; and
providing a drone pod including:
a pod shell with a top including an opening sized to receive the drone,
a door disposed in the opening, and
a motor drivingly connected to the door; and
actuating the motor to open and close the door responsive to an operation of the drone.

12. The method of claim 11, further comprising the step of actuating the motor to open the door responsive to a determination that the drone is within a predetermined distance of the pod.

13. The method of claim 11, further comprising the steps of:
providing a battery within the pod;
providing an inductive battery charger electrically connected to the battery; and
charging a drone battery wirelessly in the pod when the drone is within the pod.

14. The method of claim 11, further comprising the steps of:
providing a docking station sensor responsive to a presence of the drone within the pod;
determining that the drone is within the pod based on data from the docking station sensor; and
actuating the motor to close the door responsive to the determination that the drone is within the pod.

15. The method of claim 11, further comprising the steps of:
providing a wireless transceiver allowing communication between the pod and the drone; and
communicating data over the wireless transceiver.

16. The method of claim 11, further comprising the steps of:
providing a selectively actuatable door lock having a first condition in a locked mode and a second condition in an unlocked mode;
providing a door-closed sensor responsive to the door in a closed position;
determining that the door is closed based on data from the door-closed sensor; and
actuating the door lock to place it in the locked mode responsive to a determination that the door is closed.

17. The method of claim 11, further comprising the steps of:
providing a door-open sensor located at a start of travel position of the door;
determining that the door is open based on data from the door-open sensor;
communicating a signal to the drone indicative of the door being open responsive to a determination that the door is open; and
landing the drone inside the pod after receiving the signal indicative of the door being open.

18. The method of claim 17, further comprising the steps of:
providing a door-closed sensor located at an end of travel position of the door;
providing a docking station sensor responsive to a presence of the drone within the pod;
determining that the drone is within the pod based on data from the docking station sensor;
actuating the motor to close the door responsive to the determination that the drone is within the pod; and
determining that the door is closed based on data from the door-closed sensor.

19. The method of claim 11, further comprising the steps of:
providing a GPS sensor in the pod;
providing a GPS sensor in the drone; and
determining a distance between the pod and the drone based on data from the GPS sensors.

20. The method of claim 11, further comprising the steps of:
providing a drone proximity sensor;
determining a distance of the drone from the pod based on data from the proximity sensor; and
actuating the motor to open the door when the drone is within a predetermined distance of the pod.
